(19) United States
(12) Patent Application Publication
(10) Pub. No.: US 2021/0139201 A1
(43) Pub. Date: May 13, 2021

(54) Cap With Cork Insert

(71) Applicant: ELC Management LLC, Melville, NY (US)

(72) Inventor: Herve Georges Buzot, Mendham, NJ (US)

(21) Appl. No.: 16/677,232

(22) Filed: Nov. 7, 2019

(51) Int. Cl. B65D 39/00; B65D 43/02

(52) U.S. Cl. CPC B65D 39/0058; B65D 43/0214; B65D 39/007

(57) ABSTRACT

Cork inserts for friction fit caps have advantages over conventional thermoplastic inserts. These include: a unique sensorial feel for the user; avoiding the expenses associated with tooling and molding of plastic inserts; and reducing the amount of plastic in the waste stream. The cork insert is particularly attractive when used with caps that are made of natural materials, but can also used to reduce the carbon footprint of any cap that would otherwise us a plastic insert.

### FIELD OF THE INVENTION

The invention is in the field of friction fit caps, especially caps that incorporate natural, biodegradable materials.

### BACKGROUND

The use of cork for sealing certain types of containers is well known. Cork comes from the bark of the cork oak tree (Quercus suber), and its most common use, as a stopper for glass bottles, is ancient. Three properties, in particular, render cork suitable for sealing containers. These are elasticity, impermeability and chemical inertness.

The Poisson's ratio of cork is close to zero. For a cylindrical cork stopper, this means that the transverse radius of the stopper does not change significantly when compressed or stretched in the axial direction. This property allows a cork stopper to create an effective seal when forced into the mouth of a bottle, even when the mouth of the bottle presents with some degree of out-of-roundness. Cork is not perfectly impermeable to gases. However, on the time scale of most retail consumer products, cork is sufficiently impermeable to liquids, solids and the ambient atmosphere. Cork is chemically inert with respect to many chemicals and materials. Thus, it will not react with a product that is stored in the container, and will not alter the characteristics of the product.

In addition to bottle stoppers, cork is also used as gaskets and liners in sealing systems. For example, the classic crown seal closure had a flat cork liner fixed in the underside of the metal top plate. When a crown seal closure is applied to a bottle mouth, the cork liner rests on top of the bottle mouth, and specifically does not contact the sides of the bottle finish.

In the field of friction fit caps, a cap may be applied to a container finish or to a collar that has been fastened to a container finish. As is well known in the art, an opening in the bottom of the cap is designed to receive the container finish or collar. The inner dimeter of the opening is slightly smaller than the outer diameter of the container finish or collar. This interference creates a snug fit, and the cap will not normally fall off when the container is inverted. To be practical and effective, the opening of the cap has an inner surface that is made of a material that exhibits some degree of elasticity. This allows the cap to stretch over and effect a grip on the container finish or collar, and then return to its original dimensions when removed from the container. For this reason, the inner surface of a friction fit cap is most often made of plastic. For example, the whole cap may be molded as a single plastic component. Alternatively, the cap may be comprised of two or more components. For example, an outer cap may be fashioned of one or more materials (such as, plastic, metal, glass, wood, etc.), while a plastic insert is fixed in the opening of the outer cap. In either case, non-biodegradable materials, such as plastic, eventually enter the waste stream. These materials will end up in a landfill or undergo recycling, which incurs a cost, and which is not completely without its own environmental impact.

### OBJECTS OF THE INVENTION

A main object of the invention is to provide an environmentally-friendly cap that reduces or eliminates the use of non-biodegradable materials.

Another object of the invention is to provide a fully biodegradable cap made of natural, renewable materials.

### SUMMARY

In friction fit caps, the invention consists in replacing plastic molded cap inserts with cork inserts. The advantages of cork inserts over conventional thermoplastic inserts include: a friction fit with unique sensorial feedback to the user; avoiding the expenses associated with tooling and molding of plastic inserts; and reducing the amount of plastic in the waste stream. The “green” aspect of a cork insert is particularly attractive when used with wood caps, but can also reduce the carbon footprint of any cap that uses a plastic insert.

### DESCRIPTION OF THE FIGURES

FIG. 1 shows a container with pump dispenser, and a first embodiment of a friction fit cap, with cork insert in cross section.

FIG. 2 is a bottom plan view of the friction fit cap of FIG. 1.

FIG. 3 is a cross sectional view of a second embodiment of a friction fit cap with cork insert.

FIG. 4 is a bottom plan view of the friction fit cap of FIG. 3.

FIG. 5 shows a container with pump dispenser, and a third embodiment of a friction fit cap, with cork insert in cross section.

### DETAILED DESCRIPTION

Throughout the specification, the term comprising means that a collection of objects may not be limited to those explicitly recited.

A cap according to the present invention may be applied directly to a container finish or to a collar that has been fastened to the container finish. One type of container system that uses a collar is a container that has an attached pump dispenser. The pump dispenser attaches to the container finish, and a cap is applied to the collar of the pump dispenser. While the present invention is not limited to containers with pump dispensers, the following description will describe the situation where the cap is applied to a collar. However, applying a cap of the invention directly to a container finish is also possible.

Referring to FIGS. 1 and 2, a container (10) is closed by a pump dispenser (7) that supports a collar (7a). A friction fit cap according to a first embodiment of the present invention comprises an outer cap (1), a cork insert (4) and an optional overshell (6). The outer cap has one or more side walls (1a), a closed top (1b) and an opened bottom (1c) that, together, define an interior (2). The interior is able to receive the collar (7a) of the pump dispenser (7). The one or more side walls form an inner surface (3) that faces the interior of the outer cap. Preferably, the cross sectional shape of the inner surface will match the cross sectional shape of the collar. In the embodiment of FIGS. 1 and 2, the inner surface (3) and may be understood to be cylindrical, and characterized by a diameter, D, but this shape is not essential, so that the inner surface formed by the one or more side walls may be non-cylindrical. An insert (4) in the form of a cork strip or cork liner is affixed to a portion of the inner surface (3). The cork liner may be held in place with adhesive. The cork insert is preferably a single strip of cork that is substantially equal in length to the circumference of the inner surface (3). Alternatively, the insert may comprise more than one strip of cork, the total length of all strips being equal to or less than the circumference of the inner surface. An optional overshell (6) is shown.

A second family of embodiments of the invention, as shown in FIGS. 3 and 4, comprises an outer cap (1) and a cork insert (4). The outer cap has one or more side walls (1a), a closed top (1b) and an opened bottom (1c) that together, define an interior (2). The interior is able to receive the collar of a pump dispenser (not shown). The one or more side walls form an inner surface (3) that faces the interior of the cap. A shoulder (5), located in the side wall, defines a lower portion (3a) of the inner surface (3), between the shoulder and the opened bottom (1c). Preferably, the cross sectional shape of the lower portion of the inner surface matches the cross sectional shape of the collar. In this case, the cross sectional shape of the lower portion is square, which is appropriate when the collar that is to be inserted into the interior is square. The square shape of the lower portion of inner surface is characterized by a perimeter whose length is equal to four times the length, L, of one side of the square. An insert (4) in the form of a cork strip or cork liner is affixed to the lower portion (3a) of the inner surface (3). The cork strip liner may be held in place with adhesive. The cork insert is preferably a single strip of cork that is substantially equal in length to the perimeter of the lower portion (3a) of the inner surface (3). Alternatively, the insert may comprise more than one strip of cork, the total length of all strips being equal to or less than the perimeter of the lower portion.

The embodiments of FIGS. 1 and 2 replace the conventional plastic molded cap insert with one or more flexible cork strips that easily conform to the shape of the cap opening and the collar. This is a big advantage, because the plastic cap inserts must be molded to the shape of the opening and the collar. Different caps and different collars require different plastic inserts, one molded for the specific combination of cap and collar. This is a costly, time consuming process. In contrast, given a specific outer cap and collar, the outer cap has only to be lined with a cork strip of a certain thickness, to ensure the right amount of friction. The cork liner provides a unique, up scale sensorial feedback to the user, while eliminating plastic components. When the side walls (1a) and closed top (1b) of the outer cap (1) are made of wood, stone, or other natural, biodegradable materials, then the whole cap assembly is environmentally friendly. Preferably, entire outer cap (1) is made of biodegradable materials.

Cork stock can be purchased in rolls that are several millimeters up to one meter wide. As the cork stock is fed from a roller, strips can be cut to the required length and width. The cork strips can be rolled onto a mandrel, and held in place by suction. Adhesive can then be applied to one side of the cork strip. The outer caps are fed from down a line, and the opened bottom end of each outer cap is made to align with the mandrel. The mandrel is then moved inside the outer cap. Next, the suction is released to allow the cork strip to open, and adhere to the inner surface of the outer cap.

A strip of cork liner that is useful in the present invention may typically have the following dimensions. The thickness of the cork strip may be from 0.5 mm to 2.0 mm, preferably 0.5 mm to 1.0 mm. This makes the strip flexible, so that it will easily contour to the shape of the surface to which it is applied. The width of the cork strip may be from 2 mm to 15 mm, preferably 5 mm to 10 mm. When assembled into the outer cap (1), the diameter (d, or other relevant lateral dimension) of the exposed surface (4a) of the cork strip (4) should be smaller than the outer diameter of the collar (7a). When the collar is forced into the interior (2) of the outer cap, the cork strip compresses around the collar and effects a firm grip on the collar. When the outer cap is removed from the collar, the cork strip will return to its original dimensions, and can be used again and again. Generally, the diameter (d) of the exposed surface (4a) of the cork strip (4) will be smaller than the outer diameter of the collar (7a) by about 0.1 m to 1.0 mm, preferably by about 0.2 mm to 0.8 mm, and more preferably by about 0.4 mm to 0.6 mm.

A third embodiment of the invention is represented in FIG. 5, where a container (20) is closed by a pump dispenser (27) that supports a collar (27a). This embodiment does not use a strip of cork liner. Rather a machined cork component is used as an insert for an outer cap. Referring to FIG. 5, an outer cap (21) has an inner surface (23) that supports a cork insert (24). A lateral portion (24a) of the cork insert is affixed to the inner surface of the outer cap by an adhesive or other means. The cork insert is machined to have an opened bottom (24d) and an interior (22) that is bounded by an inner surface (24b). The interior is able to receive the collar (27a) of a pump dispenser (27) by forming a friction fit engagement between the collar and a portion of the inner surface (24b). The engagement is such that the cap will not separate from the collar if the container (20) is inverted. Preferably, the cross sectional shape of the inner surface (24b) of the cork insert will match the cross sectional shape of the collar. When the collar is inserted through the opened bottom (24d) of the cork insert (24), a portion of the inner surface (24b) will compress around the collar and effect a firm grip on the collar. When the outer cap is removed from the collar, the cork insert will return to its original dimensions, and can be used again and again. The inner surface (24b) may have a shoulder (25) that defines a lower portion (24c) of the inner surface between the shoulder and the opened bottom (24d) of the cork insert. In this case, the friction fit occurs between the collar this lower portion of the inner surface. Generally, the inner diameter of that portion of the cork insert that contacts the collar (27a) will be smaller than the outer diameter of the collar by about 0.1 m to 1.0 mm, preferably by about 0.2 mm to 0.8 mm, and more preferably by about 0.4 mm to 0.6 mm.

The embodiment of FIG. 5 replaces the conventional plastic molded cap insert with a machined cork insert that easily conforms to the shape of a collar that is inserted into it. This is a big advantage. The cork insert provides a unique, up scale sensorial feedback to the user, while eliminating plastic components. When the side walls and closed top of the outer cap (21) are made of wood, stone, or other natural, biodegradable materials, then the whole cap assembly is environmentally friendly. Preferably, entire outer cap (21) is made of biodegradable materials.

1. A friction fit cap that comprises:
an outer cap (1) that has one or more side walls (1a) that form an inner surface (3), a closed top (1b), and an opened bottom (1c) that, together, define an interior (2) that is able to receive a container finish or collar (7a);
a cork insert (4) affixed to a portion of the inner surface (3) of the one or more side walls (1a).

2. The friction fit cap of claim 1 wherein the cork insert (4) is in the form of one or more strips of cork that have a thickness from 0.5 mm to 2.0 mm.

3. The friction fit cap of claim 2 wherein the width of the one or more cork strips is from 2 mm to 15 mm.

4. The friction fit cap of claim 1 wherein:
the inner surface (3) of the one or more side walls (1a) is cylindrical, and
the cork insert is a single strip of cork that is substantially equal in length to the circumference of the inner surface.

5. The friction fit cap of claim 3 wherein:
the one or more side walls (1a) have a shoulder (5) that defines a lower portion (3a) of the inner surface (3) between the shoulder and the opened bottom (1c), and
the cork insert is affixed to the lower portion (3a) of the inner surface (3).

6. The friction fit cap of claim 5 wherein the inner surface (3) is non-cylindrical.

7. The friction fit cap of claim 1 wherein the one or more side walls (1a) and closed top (1b) are made of one or more of wood, ceramic and stone.

8. The friction fit cap of claim 1 wherein the one or more side walls (1a) and closed top (1b) are made of biodegradable materials.

9. A friction fit cap comprising:
an outer cap (21) that has an inner surface (23);
a cork insert (24) that has:
an interior (22) that is bounded by an inner surface (24b), and
a lateral portion (24a) that is affixed to the inner surface (23) of the outer cap (21),
wherein the interior is able to receive a collar (27a) by forming a friction fit engagement between the collar (27a) and a portion of the inner surface (24b).

10. The friction fit cap of claim 9 wherein the outer cap (21) is made of one or more of wood, ceramic and stone.

11. The friction fit cap of claim 9 wherein the outer cap (21) is made of biodegradable materials.
